(19) United States
(12) Patent Application Publication
(10) Pub. No.: US 2011/0122055 A1
(43) Pub. Date: May 26, 2011

(54) LIQUID CRYSTAL DISPLAY WITH DOUBLE DATA LINES

(75) Inventor: JEO-YI LEE, Miao-Li County (TW)

(73) Assignee: CHIMEI INNOLUX CORPORATION, Miao-Li County (TW)

(21) Appl. No.: 12/949,794

(22) Filed: Nov. 19, 2010

(30) Foreign Application Priority Data
Nov. 25, 2009 (CN) 200910310376.1

(51) Int. Cl. G09G 3/36

(52) U.S. Cl. 345/92

(57) ABSTRACT

A liquid crystal display (LCD) includes a liquid crystal panel including a plurality of parallel scanning lines, a plurality of parallel data lines having a plurality of data line groups, and a pixel matrix. Each data line group includes a left data line and a right data line. The pixel matrix includes a plurality of pixel units each having a thin film transistor (TFT), a pixel electrode, and a common electrode. Each column of pixel units corresponds to one of the data line groups. Two adjacent rows of pixel units correspond to one of the scanning lines. Gate electrodes of the TFTs of the two adjacent rows of pixel units are electrically coupled to the corresponding scanning line. Source electrodes of the TFTs of two pixel units located in the same column and electrically coupled to a same scanning line are electrically coupled to the left data line and the right data line of the corresponding data line group respectively.

### BACKGROUND

1. Technical Field

The present disclosure relates to liquid crystal display (LCD) technology, and more particularly, to an LCD having double data lines.

2. Description of Related Art

LCDs have the advantages of portability, low power consumption, and low radiation, and thus are widely used in various portable information products, such as notebooks, personal digital assistants, video cameras, and the like.

FIG. 8 is a partial circuit diagram of a commonly used LCD 10. The liquid crystal display 10 includes a scanning driver 11, a data driver 12, a plurality of parallel scanning lines 13, a plurality of parallel data lines 14 perpendicular to the scanning lines 13, and a plurality of pixel units 110 cooperatively defined by the intersecting scanning lines 13 and data lines 14.

In the LCD 10, the scanning lines 13 are electrically coupled to the scanning driver 11 for receiving scanning signals, and the data lines 14 are electrically coupled to the data driver 12 for receiving data signals. Each pixel unit 110 includes a thin film transistor (TFT) 15, a storage capacitor 16, a liquid crystal capacitor 17, a pixel electrode 18, and a common electrode 19. A gate electrode of the TFT 15 is electrically coupled to a corresponding scanning line 13, and a source electrode of the TFT 15 is electrically coupled to a corresponding data line 14. Further, a drain electrode of the TFT 15 is electrically coupled to the pixel electrode 18. The storage capacitor 16 is electrically coupled between the drain electrode of the TFT 15 and the common electrode 19, and parallel to the liquid crystal capacitor 17.

In operation, the scanning driver 11 provides a plurality of scanning signals to the scanning lines 13 sequentially so as to switch the TFT 15 on and thereby activate the pixel unit 110. The data driver 12 provides a data signal to charge the liquid crystal capacitor 17 and the storage capacitor 16 by means of the corresponding data line 14 and the TFT 15. Accordingly, an electric field generated within the liquid crystal capacitor 17 reorients liquid crystal molecules in the pixel unit 110 to desired angles, and thus a light transmission of the pixel unit 110 is controlled. As such, the pixel unit 110 is enabled to display a visual element, the aggregation of which displayed by all the pixel units 110 simultaneously constitutes an image displayed on the liquid crystal display 10.

The LCD 10 may adopt a one-line dot inversion driving method. Referring to FIG. 9, a polarity of each pixel unit 110 is opposite to that of an adjacent pixel unit 110, and the polarity of each pixel unit 110 is inverted once in every frame period. For example, the polarity of the pixel unit 110 is positive in the Nth frame period, and is inverted to negative in the (N+1)th frame period.

In the described driving method, because each data line 14 is connected to a column of pixel units 110, the polarity of the data signals transmitted through the data line 14 should alternate between positive and negative in every scanning time. Therefore, the data signals provided by the data driver 12 should have a high frequency. This may increase power consumption of the data driver 12 and the liquid crystal display 10.

What is needed is to provide an LCD that can overcome the described limitations.

### SUMMARY

An aspect of the disclosure relates to a liquid crystal display including a liquid crystal panel. The liquid crystal panel includes a plurality of parallel scanning lines for receiving scanning signals, a plurality of parallel data lines for receiving data signals, and a pixel matrix defined by the scanning lines and the data lines. The plurality of data lines are divided into a plurality of data line groups. Each data line group includes a left data line and a right data line. The pixel matrix includes a plurality of pixel units each having a thin film transistor (TFT), a pixel electrode electrically coupled to a drain electrode of the TFT, and a common electrode. Each column of pixel units corresponds to one of the data line groups and is located between the left data line and the right data line of the corresponding data line group. Two adjacent rows of pixel units correspond to one of the scanning lines. Gate electrodes of the TFTs of the two adjacent rows of pixel units are electrically coupled to the corresponding scanning line, and source electrodes of the TFTs of two pixel units located in the same column are electrically coupled to the left data line and the right data line of the corresponding data line group respectively.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views.

FIG. 1 is a partial circuit diagram of an LCD according to a first embodiment of the present disclosure.

FIG. 2 schematically illustrates polarities of pixel units of the LCD of FIG. 1 when the LCD adopts one-line dot inversion driving method.

FIG. 3 schematically illustrates polarities of pixel units of the LCD of FIG. 1 when the LCD adopts one and two lines dot inversion driving method.

FIG. 4 is a partial circuit diagram of an LCD according to a second embodiment of the present disclosure, illustrating polarities of pixel units of the LCD.

FIG. 5 is a partial circuit diagram of an LCD according to a third embodiment of the present disclosure, illustrating polarities of pixel units of the LCD.

FIG. 6 is a partial circuit diagram of an LCD according to a fourth embodiment of the present disclosure.

FIG. 7 is a partial circuit diagram of an LCD according to a fifth embodiment of the present disclosure.

FIG. 8 is a partial circuit diagram of a commonly used LCD 10.

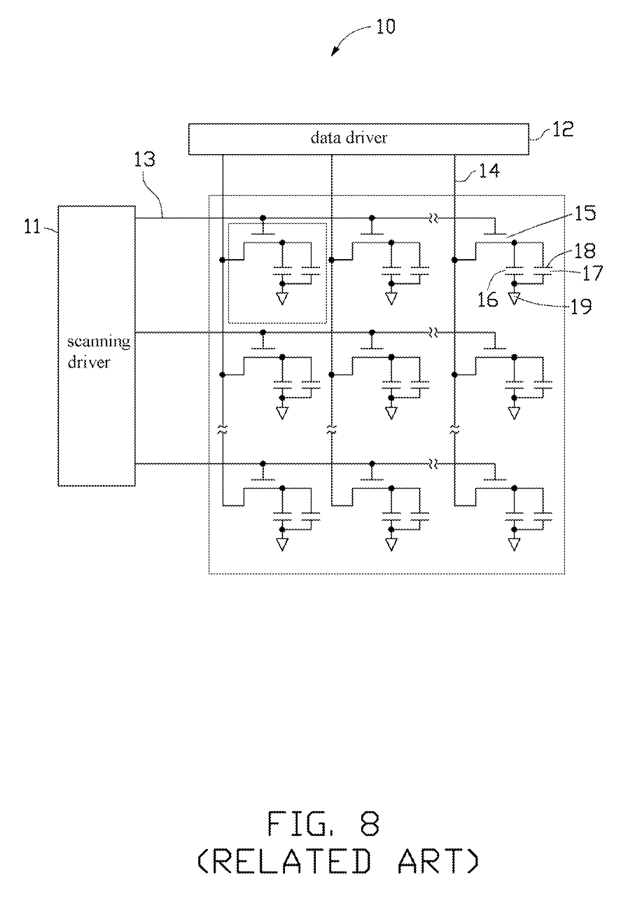

FIG. 9 is a schematic diagram of one line dot inversion driving method adopted by the LCD of FIG. 1.

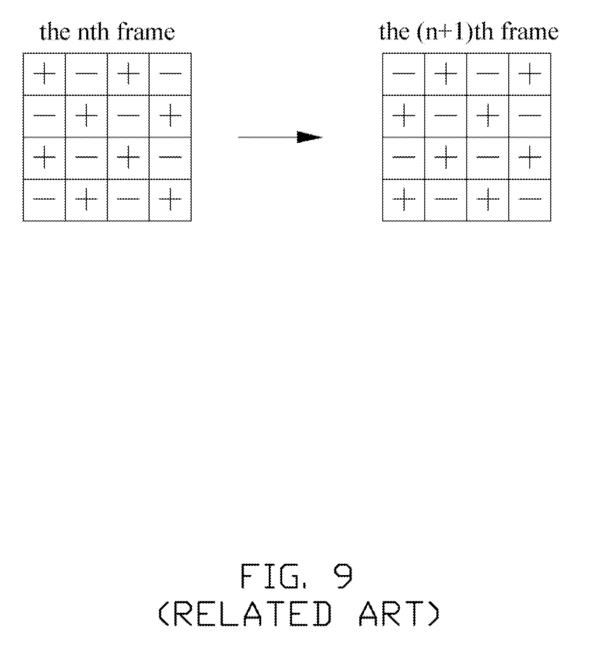

### DETAILED DESCRIPTION

Reference will now be made to the drawings to describe certain exemplary embodiments of the present disclosure in detail.

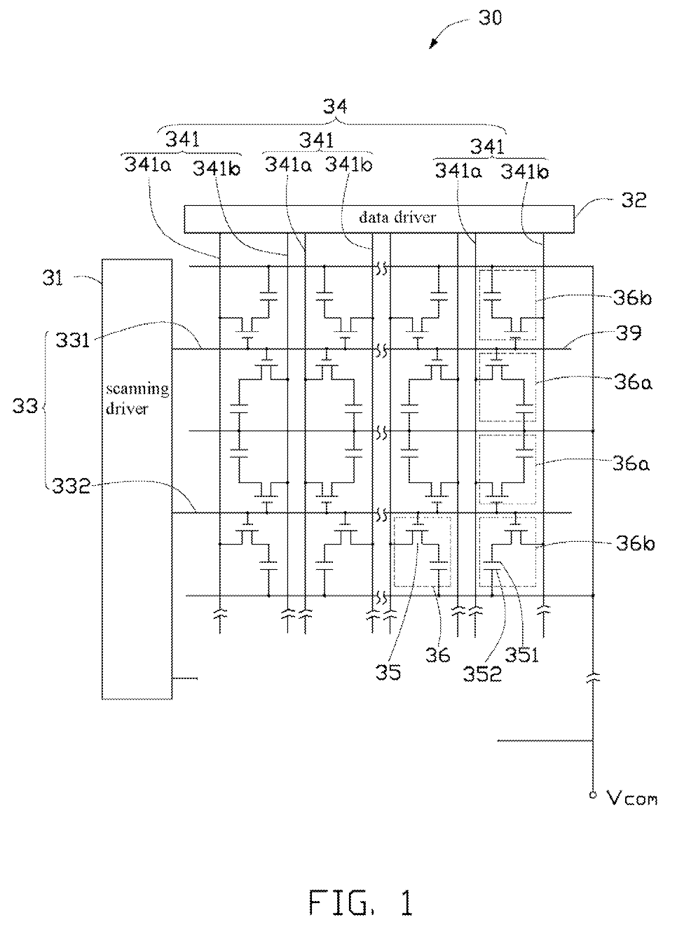

Referring to FIG. 1, a partial circuit diagram of an LCD 30 according to a first embodiment of the present disclosure is shown. The LCD 30 includes a liquid crystal panel (not labeled), a scanning driver 31, and a data driver 32.

The liquid crystal panel includes a plurality of rows of parallel scanning lines 33, a plurality of rows of parallel common lines 39 alternating with the scanning lines 33, a plurality of columns of parallel data lines 34 perpendicular to the scanning lines 33, and a plurality of pixel units 36 cooperatively defined by the crossing scanning lines 33 and data lines 34. The pixel units 36 cooperatively form a pixel matrix.

The scanning lines 33 are electrically coupled to the scanning driver 31 for receiving scanning signals, the data lines 34 are electrically coupled to the data driver 31 for receiving data signals, and the common lines 39 are electrically coupled to a common voltage driver (not shown) for receiving common voltage signals Vcom.

The data lines 34 can be divided into a plurality of data line groups 341.

The number of the data line groups 341 is same as number of columns of the pixel matrix. Each data line group 341 corresponds to a respective column of pixel units 36, and is configured for transmitting the data signals to the column of pixel units 36. Each data line group 341 may include a left data line 341a and a right data line 341b, and the column of pixel units 36 can be disposed between the left data line 341a and the right data line 341b.

The number of the scanning lines 33 is half the number of rows of the pixel matrix. Each scanning line 33 corresponds to two adjacent rows of pixel units 36, and is configured for transmitting a corresponding scanning signal to the two adjacent rows of pixel units 36. In one embodiment, each of the scanning lines 33 is located between the corresponding two adjacent rows of pixel units 36.

Each pixel unit 36 includes a thin film transistor (TFT) 35, a pixel electrode 351, and a common electrode 352. The pixel electrode 351, the common electrode 352, and a liquid crystal layer (not shown) located between the pixel electrode 351 and the common electrode 352 cooperatively constitute a liquid crystal capacitor.

Gate electrodes of the TFTs 35 of the two adjacent rows of pixel units 36 are electrically coupled to the corresponding scanning line 33. Source electrodes of the TFTs 35 of the column of pixel units 36 are electrically coupled to the left data line 341a and the right data line 341b of the corresponding data line group 341 respectively. Moreover, a drain electrode of each TFT 35 is electrically coupled to the corresponding pixel electrode 351 in the pixel unit 36. For example, in one embodiment, the source electrodes of the TFTs 35 of two pixel units 36 located in the same column and electrically coupled to a same scanning line 33 are electrically coupled to the left data line 341a and the right data line 341b of the corresponding data line group 341 respectively.

Each column of pixel units 36 can be divided into a plurality of first pixel units 36a having the TFTs 35 electrically coupled to the left data line 341a, and a plurality of second pixel units 36b having the TFTs 35 electrically coupled to the right data line 341b. In one embodiment, each and every two adjacent scanning lines 33 can be defined as a first scanning line 331 and a second scanning line 332. In each column of pixel units 36, an arrangement of the first pixel unit 36a and the second pixel unit 36b electrically coupled to the first scanning line 331 is the reverse of that of the first pixel unit 36a and the second pixel unit 36b electrically coupled to the second scanning line 332. In other words, the arrangement of the first pixel unit 36a and the second pixel unit 36b electrically coupled to the first scanning line 331 is symmetrical with that of the first pixel unit 36a and the second pixel unit 36b electrically coupled to the second scanning line 332. Furthermore, an arrangement of the first pixel units 36a and the second pixel units 36b of each column of pixel units is the reverse of that of the first pixel units 36a and the second pixel units 36b of each of two adjacent columns of pixel units 36. That is, in each row of pixel units 36, the first pixel units 36a alternate with the second pixel units 36b one by one.

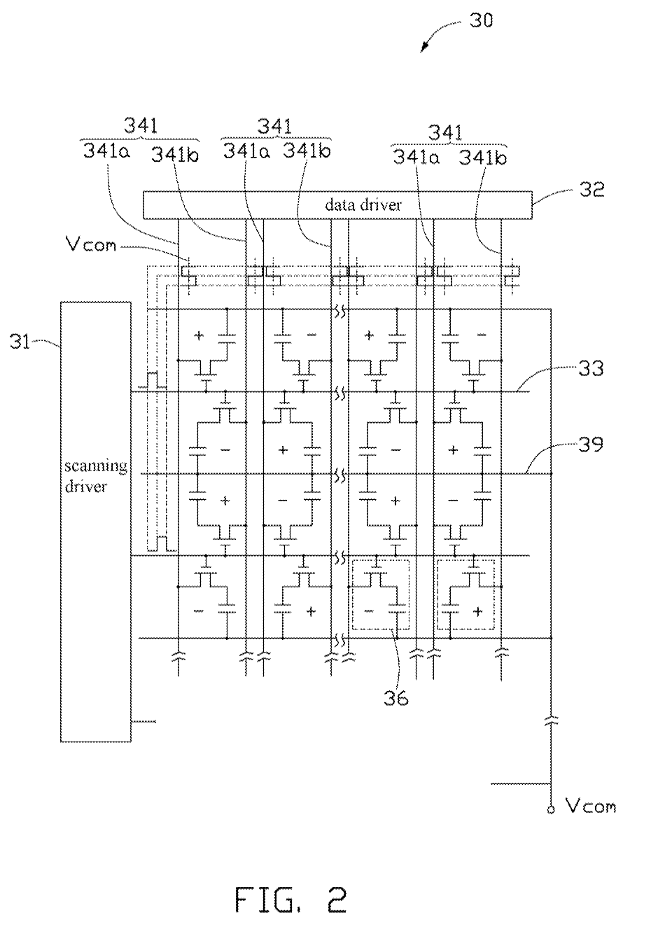

Referring to FIG. 2, the LCD 30 may adopt a one-line dot inversion driving method. In operation, the scanning driver 31 provides a plurality of scanning signals to the plurality of scanning lines 33 on by one, the common voltage driver provides a common voltage Vcom to the plurality of common lines 39, and the data driver 32 provides a plurality of data signals to the plurality of data lines 34. In each frame period, when one of the scanning lines 33 such as the nth scanning line, receives a scanning signal, the left data line 341a and the right data line 341b of each data line group 341 are provided with data signals with reversed polarities by the data driver 32. When a subsequent scanning line 33, such as (n+1)th scanning line receives the scanning signal, the data signal provided to each data line 34, that is the left data line 341a or the right data line 341a, has a polarity opposite to the data signal provided thereto upon the previous scanning line 33, such as nth scanning line being scanned. That is, during a period in which two adjacent scanning lines 33 are provided with scanning signals, and two data signals provided to the data line 34 have reversed polarities. With this configuration, in each frame period, a polarity of each pixel unit 36 in FIG. 2 is opposite to a polarity of every adjacent pixel unit 36 in the same row and the same column, and accordingly, the LCD 30 can display pictures with a one-line dot inversion manner.

Compared to the LCD 10, in the LCD 30 of the present disclosure, each scanning line 33 transmits a scanning signal to the corresponding two adjacent rows of pixel units 36, such that each frame period of the LCD 30 is a half of that of the LCD 10. Accordingly, the number of polarity inversions of data signals of each data line 34 is half that in LCD 10. This lowers the power consumption of the data driver 32 and the liquid crystal display 30.

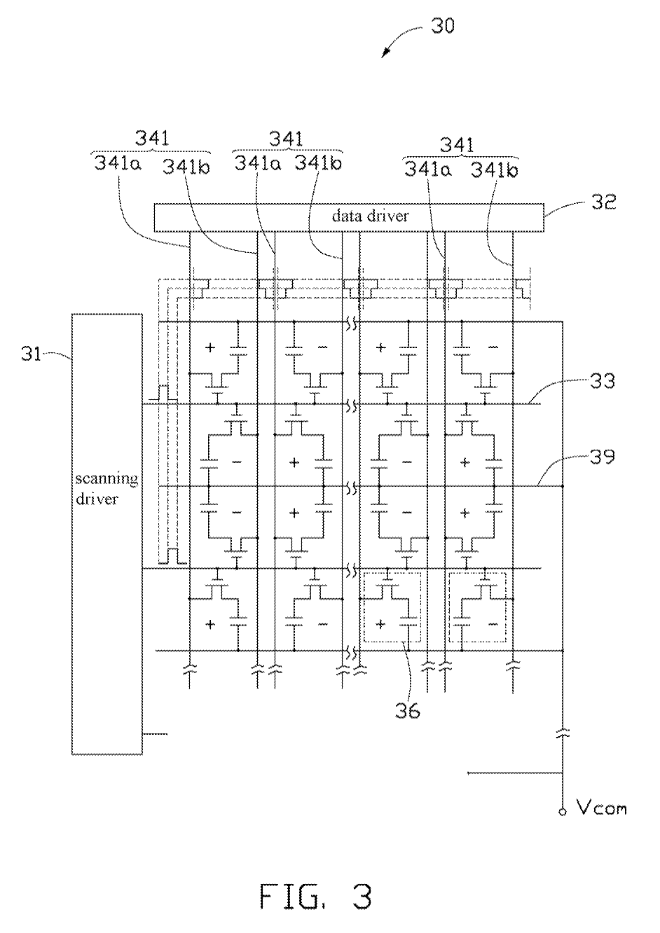

In an alternative embodiment, the LCD 30 may adopt a one and two (1+2) lines dot inversion driving method. Referring to FIG. 3, a schematic diagram of the LCD 30 of FIG. 1 using the one and two lines dot inversion driving method is shown. During the Nth frame, the data driver 32 provides data signals having a first polarity to each of left data lines 341a, and provides data signals having a second polarity opposite to the first polarity to each of right data lines 341b. During the (N+1)th frame, the data driver 32 provides data signals having the second polarity to each of left data lines 341a, and provides data signals having the first polarity to each of right data lines 341b.

With the above-mentioned one and two lines dot inversion driving method, in each frame period, the data signals of each of left data lines 341a and right data lines 341b has a fixed polarity, therefore, the power consumption of the data driver 32 and the liquid crystal display 30 can be further reduced.

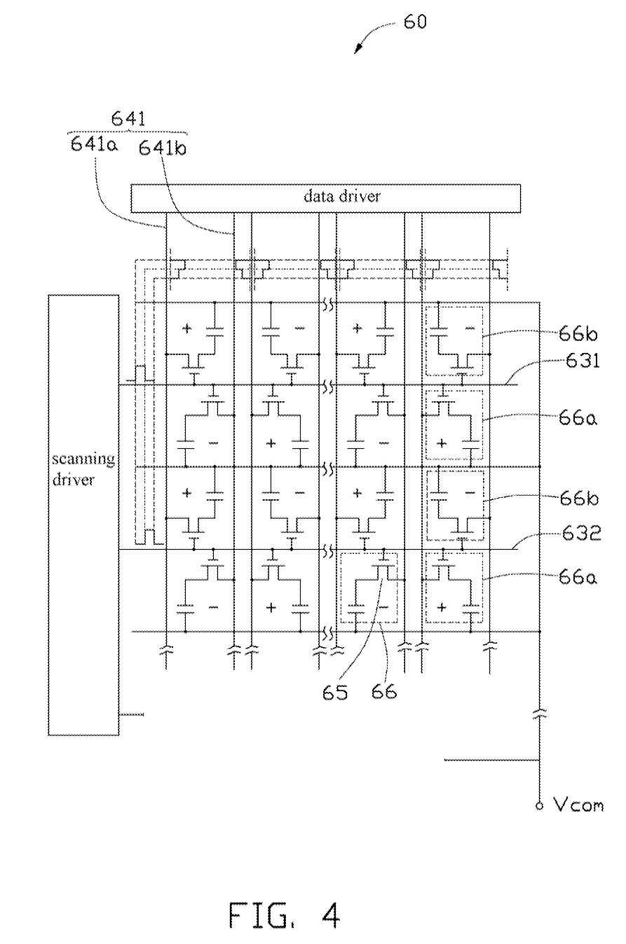

Referring to FIG. 4, a partial circuit diagram of an LCD according to a second embodiment of the present disclosure is shown, differing from that of the previous embodiment in that in each column of pixel units 66, an arrangement of a first pixel unit 66a and a second pixel unit 66b electrically coupled to a first scanning line 631 is same as that of the first pixel unit 66a and the second pixel unit 66b electrically coupled to a second scanning line 632 adjacent to the first scanning line 631. That is, in each column of pixel units 66, the first pixel units 66a alternate with the second pixel units 66b one by one.

With the configuration disclosed, when the LCD 60 adopts the one-line dot inversion driving method, in each frame time, the data signals of each of left data lines 641a and right data lines 641b have a fixed polarity, therefore, the power consumption of the data driver 62 and the liquid crystal display 60 can also be reduced.

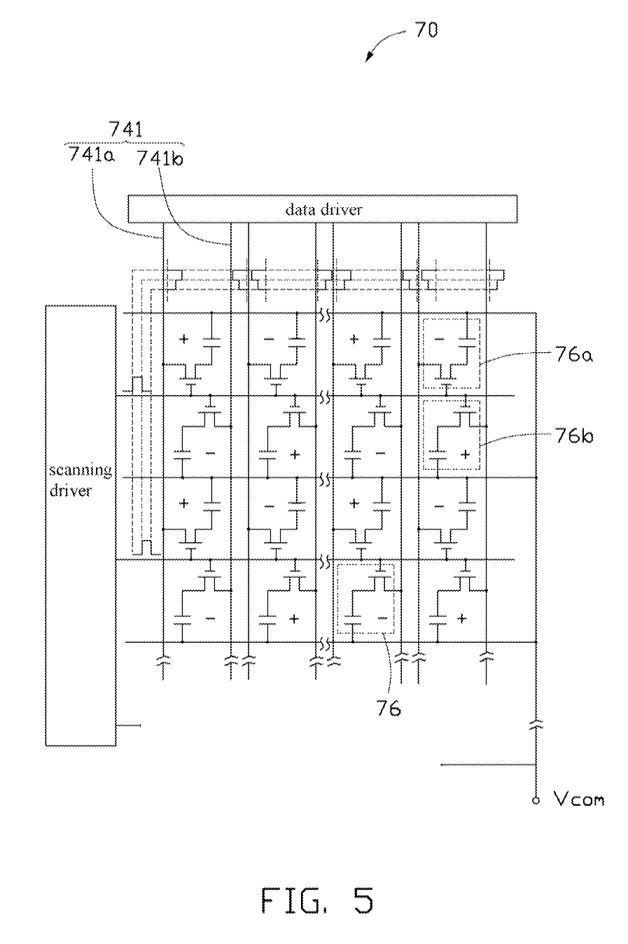

Referring to FIG. 5, a partial circuit diagram of an LCD according to a third embodiment of the present disclosure is shown, differing from the previously disclosed LCD 60 only in that: an arrangement of first pixel units 76a and second pixel units 76b of each column of pixel units 76 is the same as that of the first pixel units 76a and the second pixel units 76b of an adjacent column of pixel units 76.

With the configuration disclosed, when the LCD 70 adopts the one-line dot inversion driving method, two adjacent data lines 74 in different two adjacent data line groups are respectively provided with data signals having the same polarities in each frame period. As such, interference that may exist between the two adjacent data lines 74 may be lowered, and accordingly, stability and reliability of the LCD 70 can be improved.

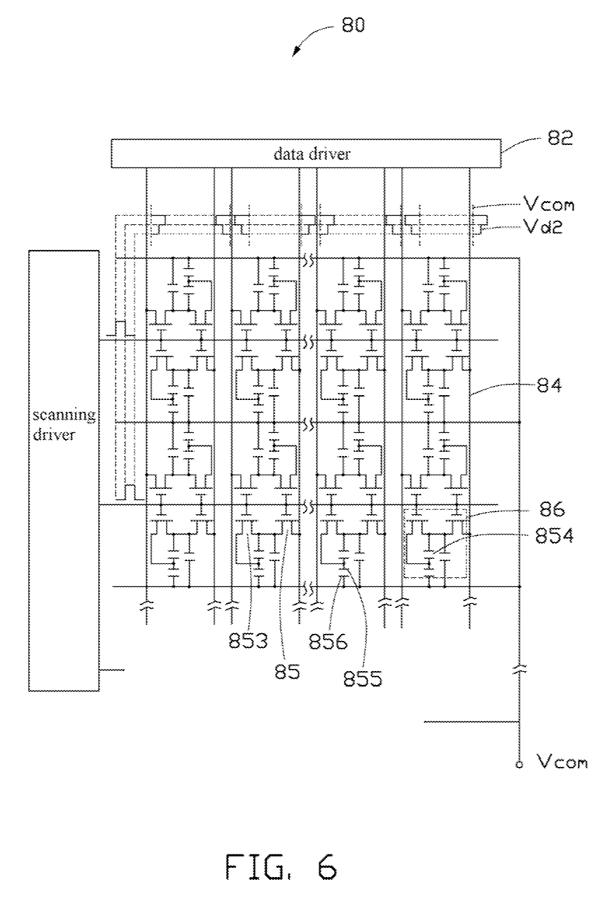

Referring to FIG. 6, a partial circuit diagram of an LCD according to a fourth embodiment of the present disclosure is shown, differing from the previous embodiment only in that each pixel unit 86 further includes a sub-TFT 853, a coupling capacitor 854, a sub-pixel electrode 855, and a sub-common electrode 856. The sub-common electrode 856 is electrically coupled to a common electrode 352. The sub-pixel electrode 855, the sub-common electrode 856, and a liquid crystal layer (not shown) located between the sub-pixel electrode 855 and the sub-common electrode 856 cooperatively constitute a sub-liquid-crystal capacitor. A gate electrode of the sub-TFT 853 is electrically coupled to a gate electrode of a TFT 85 of the pixel unit 86. A source electrode of the sub-TFT 853 is electrically coupled to a drain electrode of the TFT 85. A drain electrode of the sub-TFT 853 is electrically coupled to the sub-pixel electrode 855. The coupling capacitor 854 is electrically coupled between the source electrode and the drain electrode of the sub-TFT 853.

Due to the coupling capacitor 854, when a data signal is provided to the pixel unit 86 via a corresponding data line 84, the pixel electrode 851 and the sub-pixel electrode 855 can be applied with two different voltages. This may cause liquid crystal molecules of each pixel unit 86 to have at least two different title angles. As such, a viewing angle of the LCD 80 can be improved.

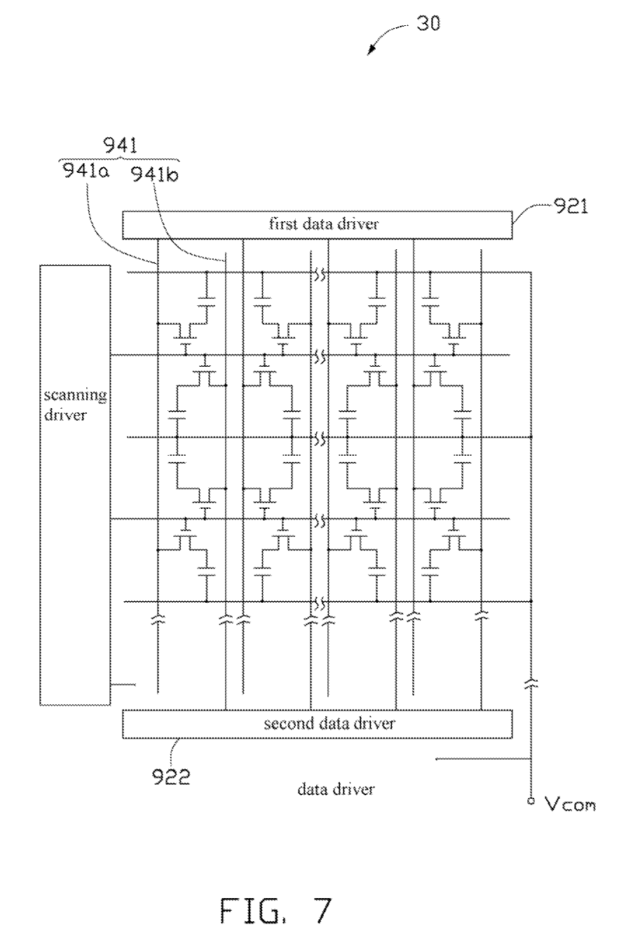

Referring to FIG. 7, a partial circuit diagram of an LCD according to a fifth embodiment of the present disclosure is shown, differing from the previous embodiment in that the LCD 90 includes a first data driver 921 electrically coupled to left data lines 941a and a second data driver 922 electrically coupled to right data lines 941b.

Because the first data driver 921 and the second data driver 922 can provide data signals to the left data lines 941a and the right data lines 941b respectively, each of the first data driver 921 and the second data driver 922 may have a simple structure, and thus a cost of the LCD 90 can be reduced.

It is to be further understood that even though numerous characteristics and advantages of a preferred embodiment have been set out in the foregoing description, together with details of the structures and functions of the embodiments, the disclosure is illustrative only; and that changes may be made in detail, especially in matters of shape, size and arrangement of parts within the principles of present invention to the full extent indicated by the broad general meaning of the terms in which the appended claims are expressed.

What is claimed is:

1. A liquid crystal display (LCD), comprising:
a liquid crystal panel, comprising:
a plurality of parallel scanning lines for receiving scanning signals;
a plurality of parallel data lines for receiving data signals, the plurality of data lines being divided into a plurality of data line groups, each data line group comprising a left data line and a right data line; and
a pixel matrix defined by the scanning lines and the data lines, the pixel matrix comprising a plurality of pixel units each comprising a thin film transistor (TFT), a pixel electrode electrically coupled to a drain electrode of the TFT, and a common electrode, each column of pixel units corresponding to one of the data line groups and being located between the left data line and the right data line of the corresponding data line group, two adjacent rows of pixel units corresponding to one of the scanning lines,
wherein gate electrodes of the TFTs of the two adjacent rows of pixel units are electrically coupled to the corresponding scanning line, and source electrodes of the TFTs of two pixel units located in the same column are electrically coupled to the left data line and the right data line of the corresponding data line group respectively.

2. The LCD of claim 1, wherein each scanning lines is located between the corresponding two adjacent rows of pixel units, each column of pixel units comprises a plurality of first pixels having the TFTs electrically coupled to the left data line and a plurality of second pixels having the TFTs electrically coupled to the right data line, wherein in a same column, the first pixel and the second pixel having the TFTs electrically coupled to a same scanning line are located at different sides of the scanning line respectively.

3. The LCD of claim 2, wherein an arrangement of the first pixel units and the second pixel units of each column of pixel units is the reverse of that of the first pixel units and the second pixel units of an adjacent column of pixel units.

4. The LCD of claim 3, wherein every two adjacent scanning lines are defined as a first scanning line and a second scanning line, and in each column of pixel units, an arrangement the first and second pixel units electrically coupled to the first scanning line is the reverse of that of the first and second pixel units electrically coupled to the second scanning line.

5. The LCD of claim 4, wherein the LCD adopts a one-line dot inversion driving method, and when the scanning signals are provided to two adjacent scanning lines, the left data line and the right data line are provided with data signals having opposite polarities.

6. The LCD of claim 4, wherein the LCD adopts a one and two lines dot inversion driving method, and in each frame period, each of the left data line and the right data line is provided with a data signal having a fixed polarity.

7. The LCD of claim 3, wherein in each column of pixel units, the first pixel units alternate with the second pixel units.

8. The LCD of claim 7, wherein the LCD adopts a one-line dot inversion driving method, and in each frame period, each of the left data line and the right data line is provided with a data signal having a fixed polarity.

9. The LCD of claim 2, wherein an arrangement of the first pixel units and the second pixel units of each column of pixel units is same as that of the first pixel units and the second pixel units of an adjacent column of pixel units.

10. The LCD of claim 9, wherein the LCD adopts a one-line dot inversion driving method, and in each frame period, each of the left data line and the right data line is provided with a data signal having a fixed polarity.

11. The LCD of claim 1, wherein the data signals of the left data line and the right data line of each data line group have opposite polarities at any time.

12. The LCD of claim 1, wherein each of two adjacent data lines in different two adjacent data line groups are respectively provided with a data signal having a fixed polarity in each frame period.

13. The LCD of claim 1, wherein each of pixel units further includes a sub-TFT, a coupling capacitor, a sub-pixel electrode, and a sub-common electrode, the sub-common electrode is electrically coupled to the common electrode, a gate electrode of the sub-TFT is electrically coupled to a gate electrode of the TFT of the pixel unit, a source electrode of the sub-TFT is electrically coupled to a drain electrode of the TFT, and a drain electrode of the sub-TFT is electrically coupled to the sub-pixel electrode, the coupling capacitor is electrically coupled between the source electrode of the sub-TFT and the drain electrode of the sub-TFT.

14. The LCD of claim 1, further comprising a first data driver electrically coupled to left data lines and a second data driver electrically coupled to right data lines.

15. A liquid crystal display (LCD), comprising:
a plurality of parallel scanning lines;
a plurality of parallel data lines, the plurality of data lines being divided into a plurality of data line groups, each data line group comprising a left data line and a right data line; and
a pixel matrix defined by the scanning lines and the data lines, the pixel matrix comprising a plurality of pixel units each comprising a thin film transistor (TFT), a pixel electrode electrically coupled to a drain electrode of the TFT, and a common electrode opposite to the pixel electrode,
wherein each scanning line corresponds to two adjacent rows of pixel units, gate electrodes of the TFTs of the two adjacent rows of pixel units being electrically coupled to the corresponding scanning line, each data line group corresponding to a respective column of pixel units, source electrodes of the TFTs of the two adjacent rows located at same column being electrically coupled to the left data line and the right data line of the corresponding data line group respectively.

16. The LCD of claim 15, wherein each column of pixel units comprises a plurality of first pixels having the TFTs electrically coupled to the left data line and a plurality of second pixels having the TFTs electrically coupled to the right data line, wherein in a same column, the first pixel and the second pixel having the TFTs electrically coupled to a same scanning line are located at different sides of the scanning line respectively.

17. The LCD of claim 16, wherein an arrangement of the first pixel units and the second pixel units of each column of pixel units is symmetrical with that of the first pixel units and the second pixel units of an adjacent column of pixel units.

18. The LCD of claim 17, wherein every two adjacent scanning lines are defined as a first scanning line and a second scanning line, and in each column of pixel units, an arrangement the first and second pixel units electrically coupled to the first scanning line is symmetrical with that of the first and second pixel units electrically coupled to the second scanning line.

19. The LCD of claim 17, wherein in each column of pixel units, the first pixel units alternate with the second pixel units.

20. The LCD of claim 16, wherein an arrangement of the first pixel units and the second pixel units of each column of pixel units is same as that of the first pixel units and the second pixel units of an adjacent column of pixel units.
